(19) United States
(12) Patent Application Publication
(10) Pub. No.: US 2021/0125743 A1
(43) Pub. Date: Apr. 29, 2021

(54) ELECTRICAL SYSTEMS FOR STRUCTURES

(71) Applicant: AECOM, Los Angeles, CA (US)

(72) Inventors: Paul J. Morgan, Swindon (GB); Sebastien Perrotin, Swindon (GB)

(21) Appl. No.: 17/081,670

(22) Filed: Oct. 27, 2020

Related U.S. Application Data
(60) Provisional application No. 62/927,594, filed on Oct. 29, 2019.

(51) Int. Cl. H01B 7/00; H02G 3/22

(52) U.S. Cl. CPC H01B 7/0045; H02G 3/22

(57) ABSTRACT

An electrical system for a building structure can include a harness comprising at least one primary bundle of a plurality of electrical wires. At least one end of one or more electrical wires of the plurality of electrical wires can comprise a tool-less electrical connector. A plurality of wire branches can extend from the at least one primary bundle, with each wire branch of the plurality of wire branches comprising a set of one or more wires from the plurality of electrical wires. The harness can be constructed such that each wire branch of the plurality of wire branches is configured to connect to one or more corresponding electrical ports of the building structure.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field of the Invention

The field relates to electrical systems for buildings, and to methods for installing electrical systems in buildings.

### Description of the Related Art

Current electrical systems 1′ for buildings 10 may be installed in a manner similar to that shown in FIGS. 1A-1E. In such systems 1′, the electrician or other installer(s) 2 may connect numerous wires 3′ to a central junction box 4′ (e.g., a fuse box or household circuit breaker). Each wire 3′ may be routed separately to corresponding electrical port(s) 5′ (such as electrical outlets 6′, switches 7′, powered devices 8′ (e.g., light bulbs) or other electrical interface terminals) in each room of the building 10. Furthermore, for each switch or outlet, wiring is individually stripped and connected to a back box 9′ which in turn is secured over a rectangular hole 14′ in a ceiling 11′ or wall 12′ (which may comprise a drywall material), and a front plate is manually connected to the back box 9′ by screws. Tools 13′ (such as a screwdriver) may be used to connect each junction box 4′, back box 9′, and/or front plate to the building structure 10. Such a routing scheme may be complex and labor-intensive, which may increase costs of installing the electrical system 1′. Accordingly, there remains a continuing demand for improved electrical systems 1′ for buildings 10.

### SUMMARY

In one embodiment, an electrical system for a building structure is disclosed. The electrical system can include a harness. The harness can comprise at least one primary bundle of a plurality of electrical wires, wherein at least one end of one or more electrical wires of the plurality of electrical wires comprises a tool-less electrical connector. The harness can include a plurality of wire branches extending from the at least one primary bundle, each wire branch of the plurality of wire branches comprising a set of one or more wires from the plurality of electrical wires. The harness can be constructed such that each wire branch of the plurality of wire branches is configured to connect to one or more corresponding electrical ports of the building structure.

In another embodiment, a method for installing an electrical system in a building structure is disclosed. The method can include connecting respective first ends of a plurality of wires to a junction box of the building structure with a first tool-less connection. The method can include connecting respective second ends of the plurality of wires to corresponding electrical ports in the building structure with a second tool-less connection.

In another embodiment, an electrical port configured to be installed in a building structure is disclosed. The electrical port can include a port body comprising a tool-less connector configured to electrically and mechanically connect to an electrical wire without using any tools.

In another embodiment, a junction box configured to be installed in a building structure is disclosed. The junction box can include a plurality of electrical connectors configured to supply electrical power to a plurality of electrical ports in the building structure. At least one electrical connector of the plurality of electrical connectors can comprise a tool-less connector configured to electrically and mechanically connect to an electrical wire without using any tools.

### BRIEF DESCRIPTION OF THE DRAWINGS

These and other features, aspects and advantages are described below with reference to the drawings, which are intended for illustrative purposes and should in no way be interpreted as limiting the scope of the embodiments. Furthermore, various features of different disclosed embodiments can be combined to form additional embodiments, which are part of this disclosure. In the drawings, like reference characters denote corresponding features consistently throughout similar embodiments. The following is a brief description of each of the drawings.

FIG. 1A is an image showing a conventional installation of a junction box in a building.

FIG. 1B is an image showing a conventional installation of an electrical outlet in the wall of a building.

FIG. 1C is an image showing a conventional installation of a powered device (e.g., a light bulb) in a ceiling of the building.

FIG. 1D is an image showing workers conducting a conventional installation of electrical port(s) in the building.

FIG. 1E is a schematic system diagram of a building having a conventional electrical system installed therein.

FIG. 2A is an image showing wires with tool-less connectors to be used in an electrical system according to various embodiments.

FIG. 2B is an image showing a harness to be used in an electrical system according to various embodiments.

FIG. 2C is a schematic system diagram of a building having an electrical system installed therein, in accordance with various embodiments disclosed herein.

FIG. 3 is a schematic perspective view of an electrical port to be installed in the electrical system of FIG. 2C.

FIG. 4 is a schematic perspective view of the electrical port of FIG. 3 installed in a wall of a building.

FIG. 5 is a schematic rear end view of the electrical port of FIG. 3.

### DETAILED DESCRIPTION

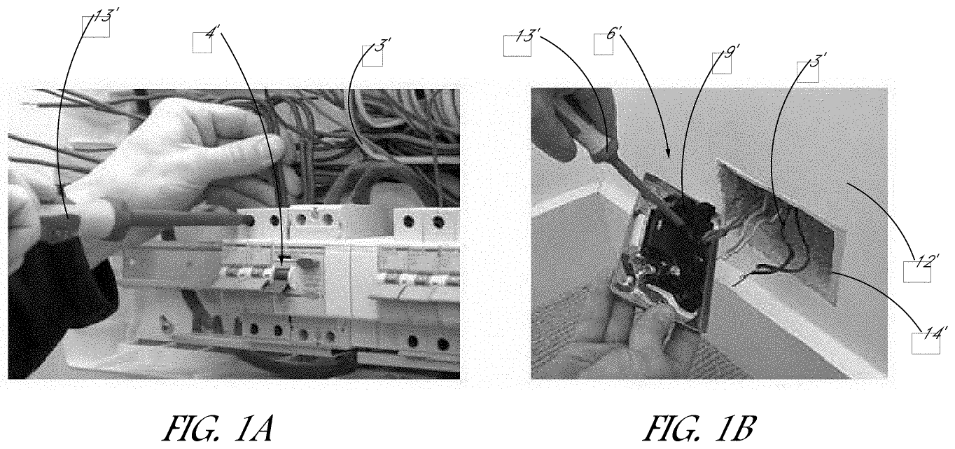

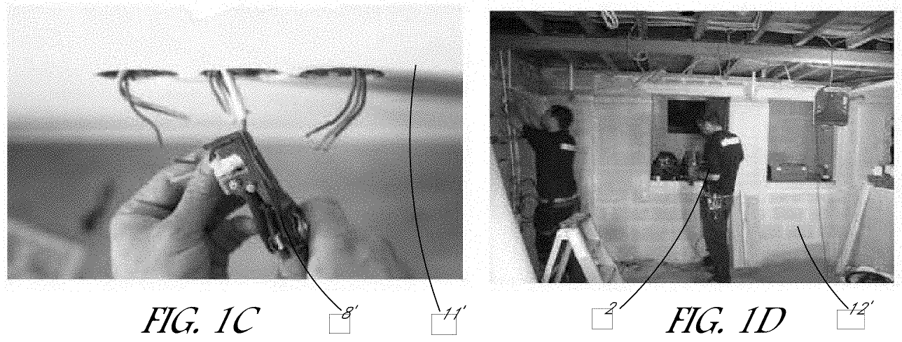

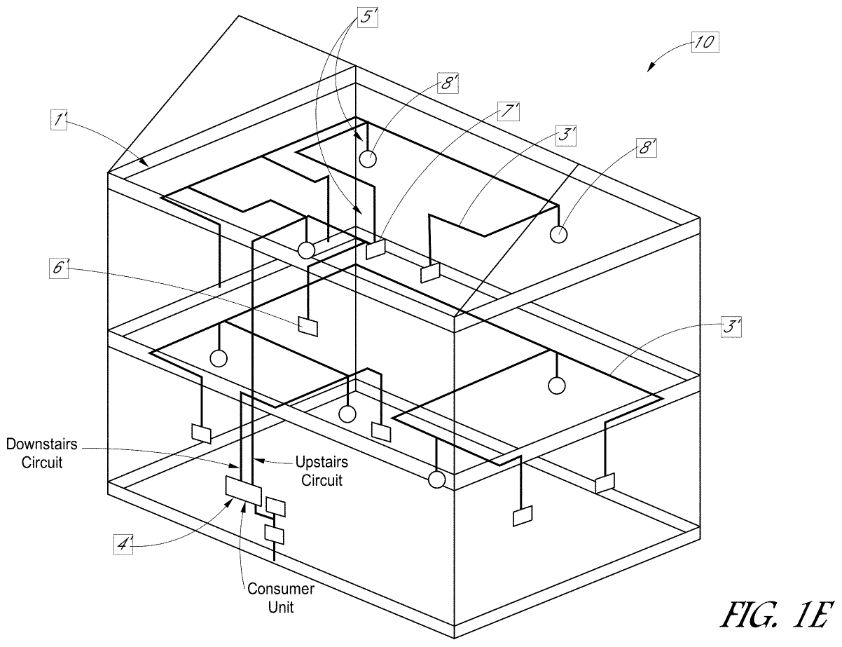

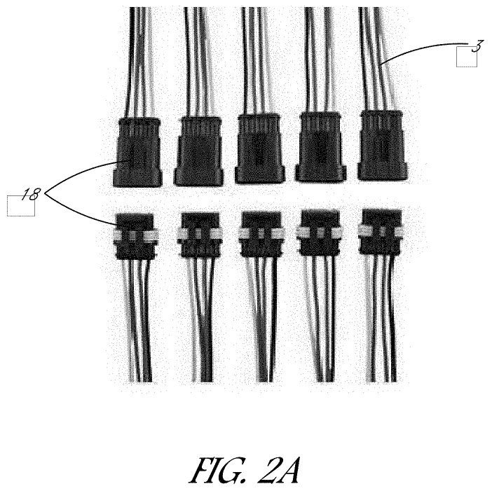

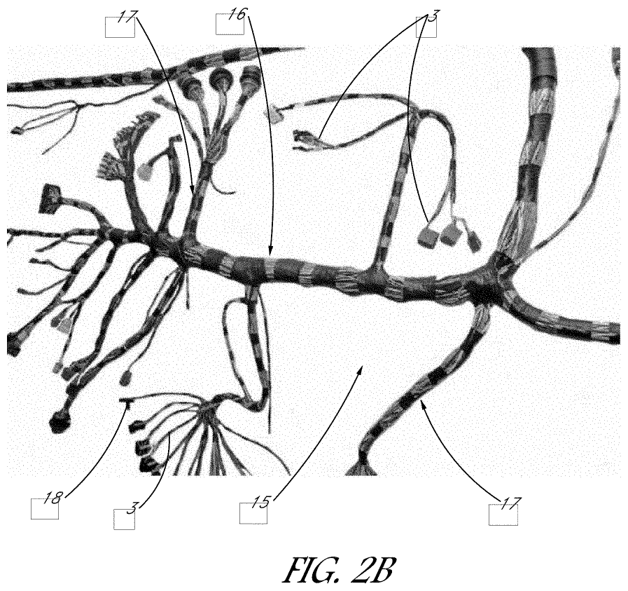

Various embodiments disclosed herein provide cost-effective and efficient methods for installing an electrical system in a structure, such as a building structure 10 (e.g., a single- or multi-level house, a multi-level commercial building, an industrial building, etc.). In conventional electrical systems 1′, as shown in FIGS. 1A-1E, the electrician 2 brings coil(s) of wires 3′ to the structure 10 and individually measures each wire 3′ so that it has a length that is sufficient to reach the corresponding electrical port 5′ (such as a power outlet 6′, light switch 7′, powered device 8′, etc.). The electrician 2 typically strips the insulation from a first end of the wire 3′ to expose the metal wire and uses tools 13′ (such as a screwdriver) to connect the first end of the wire 3′ to a junction box 4′ of the structure 10. After routing the wires 3′ through the structure 10 to the corresponding electrical ports 5′ elsewhere in the building 10, the electrician 2 strips a second end of the wire 3′ to expose the metal wire and uses tools 13′ to connect the second end of the wire 3′ to the electrical port 5′ (e.g., light switch 7′, outlet 6′, etc.). Moreover, the electrician 2 typically installs a back box 9′ at every electrical port 5′ to insulate the stripped wires 3′ and serve as a fire barrier. Installing the back box 9′ involves cutting a rectangular hole 14′ in the ceiling 11′ or wall 12′ (e.g., which can comprise drywall) and securing the back box 9′ over the hole 14′, typically also using tools 13′. The wiring is connected to the back box 9′ using tools 13′, and the switch or outlet plate, serving as the electrical port 5′, is mechanically fixed to the ceiling 11′ or wall 12′ of the building structure 10 with a tool 13′, such as by screwing the plate into the back box 9′ using a screwdriver.

Thus, in conventional electrical systems 1′, the electrician and/or other laborers separately select and route wires 3′ to the corresponding electrical ports 5′, installing the wires 3′ and ports 5′ with tools 13′ that take a lot of time and effort to use. Moreover, excess wire is typically employed for every electrical port 5′ to ensure that a sufficient length is provided. For example, the electrician or laborer can thread wire(s) 3′ from the central junction box 4′ to the approximate location of the electrical port 5′, and can utilize an extra length of wire (e.g., about 1 meter in some instances) for slack. The waste of excess wire 3′ and the excessive time that it takes to install the wires 3′ can increase the costs of installing the electrical system 1′.

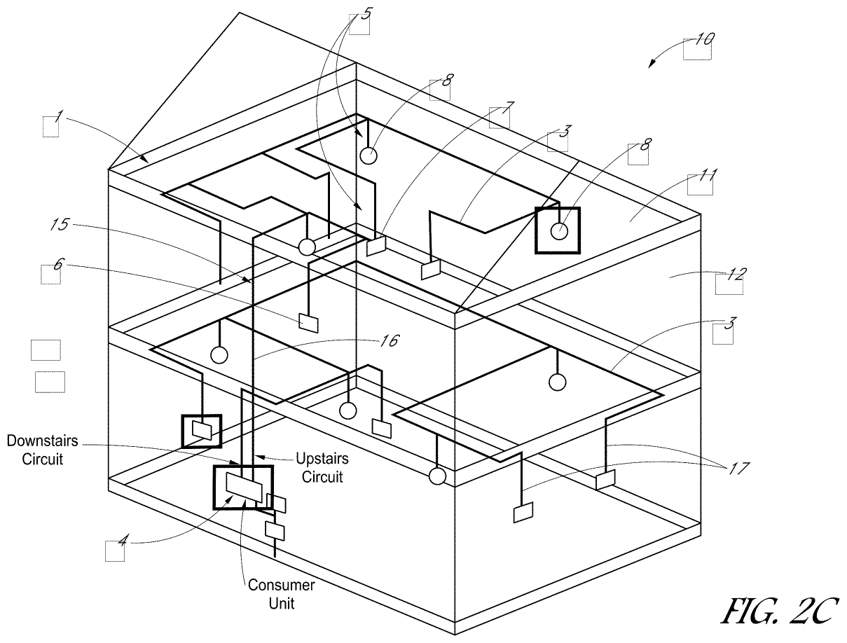

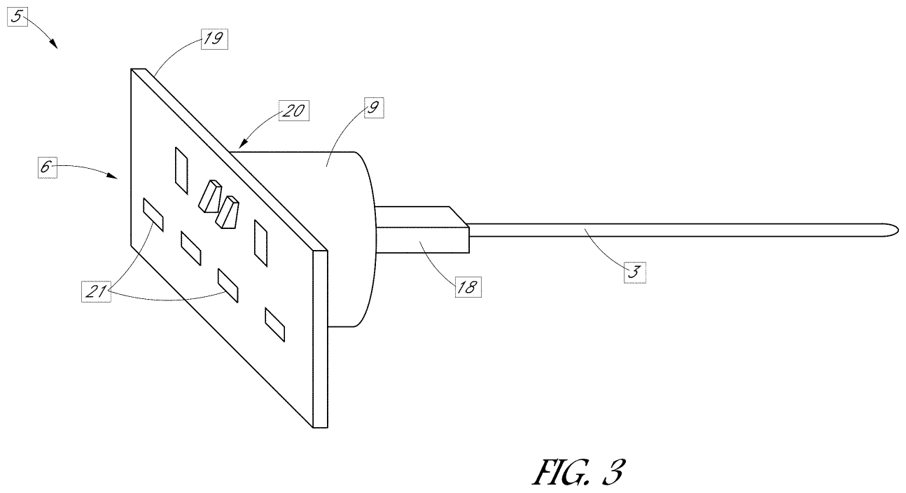

Various embodiments disclosed herein can reduce the costs and time that it takes to install electrical systems in building structures 10 such as houses, commercial buildings, industrial sites, etc. FIGS. 2A-2C illustrate an example of an electrical system 1, according to various embodiments. The building structure 10 of FIG. 2C is generally similar to that shown in FIG. 1E, except the electrical system 1 of the disclosed embodiments is installed in the building structure 10 of FIG. 2C. Beneficially, the electrical system 1 can be designed off-site in a modular manner such that the electrical wires 3 have lengths and are organized (for example in a common harness 15) to connect to pre-determined electrical ports 5 in one or more rooms of the structure 10. Moreover, tool-less connections 18 (e.g., snap-fit or clip connections) can be used to connect the wire(s) 3 to the junction box 4 and to the corresponding electrical port 5. As shown in FIG. 2A, for example, ends of the wires 3 can have different (e.g., complementary) tool-less connections for connection to the junction box 4 and/or the port(s) 5. In addition, tool-less connections 18 (e.g., snap-fit or clip connections) can be used to connect the electrical port(s) 5 (such as outlets, switches, etc.) to the ceiling(s) 11 or the wall(s) 12 of the structure 10. The tool-less connections 18 can advantageously obviate the use of tools such as screwdrivers, which can significantly reduce installation time and consequent labor costs.

In the disclosed embodiments, the electrician or other installer can design a harness 15, as shown in FIG. 2B, that includes a bundle of wires 3 that can be pre-selected, measured, and constructed at an off-site location. For example, as shown in FIG. 2B, the harness 15 can comprise at least one primary bundle 16 of a plurality of electrical wires 3. The harness 15 can comprise a plurality of wire branches 17 extending from the at least one primary bundle 16. Each wire branch 17 of the plurality of wire branches 17 can include a set of one or more wires 3 from the plurality of electrical wires 3. The harness 15 can be constructed such that each wire branch 17 of the plurality of wire branches 17 is configured to connect to one or more corresponding electrical ports 5 of the structure 10.

The wires 3 can be organized in a modular fashion so that each wire 3 (or bundle or branch 17 of wires 3) is configured to be routed to predetermined ports 5 in predetermined locations or rooms of the structure 10. The harness 15 can be transported to the structure 10. The electrician 2 can connect first ends of the wires 3, directly or indirectly, to the junction box 4 with a tool-less connection 18, for example, by snapping or clipping the wires 3 to the junction box 4. In one example, the harness 15 connects to a corresponding harness branch 17 that connects within the building 10 to the junction box 4 and serves a room or a floor. The branches 17 of the harness 15 with wires 3 can be routed through the structure 10. Second ends of the wires 3 can be connected to the corresponding ports 5 with a tool-less connection 18, for example, by snapping or clipping the wires 3 to the ports 5. In some embodiments, the harness 15 can connect to a corresponding harness branch 17 that connects within the building to the junction box 4 and serves a room or a floor. In various embodiments, the harness(es) 15 can be integrated into tilt-up modular walls before the walls and floors are assembled into the building 10. In some embodiments, the harness(es) 15 may be installed in walls and floors after the walls and floors are assembled into the building 10. Moreover, the electrical ports 5 can be installed into the wall(s) 12 of the building 10 with a tool-less connection 18, e.g., by clipping or snapping the ports into openings 14 of the wall(s) 12.

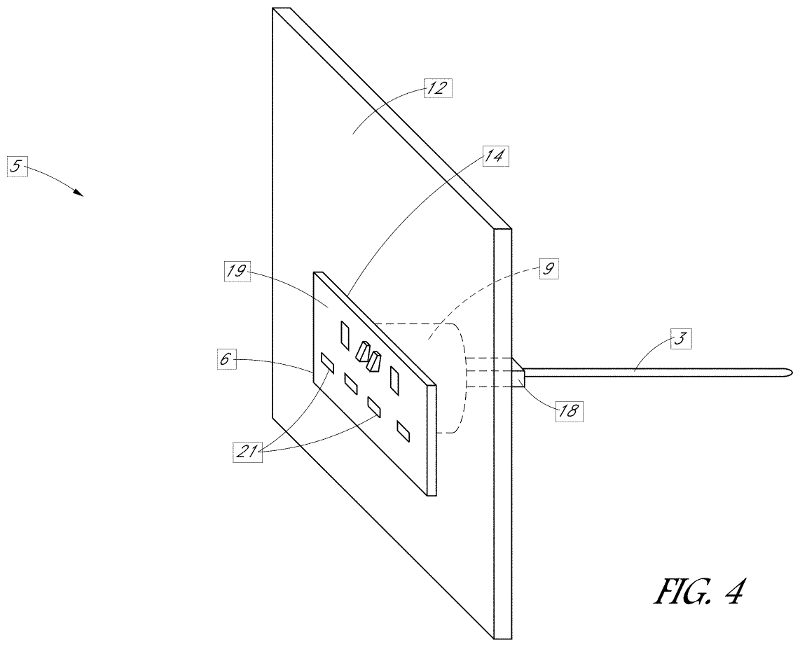

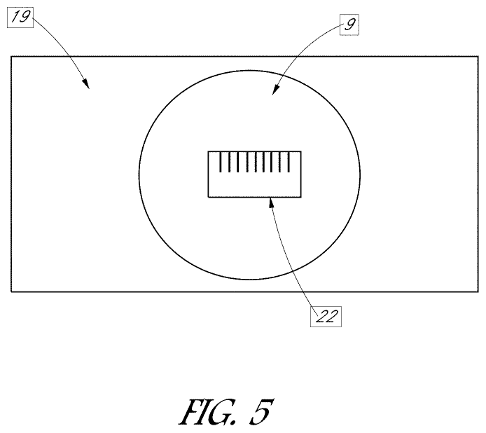

Moreover, in various embodiments, the use of the electrical system 1 disclosed herein can eliminate the use of the separate back box 9 for each port 5, e.g., for each outlet 6, switch 7, powered device 8, or other type of electrical port 5. For example, FIGS. 3-5 illustrate an example of an electrical port 5 comprising one or a plurality of electrical outlets 21 and having a port body 20 integrated with or coupled to a back box 9 and a wall or front plate 19. FIG. 3 illustrates the electrical port 5 without being installed in the building 10. FIG. 4 illustrates the electrical port 5 installed in a wall 12 of the building 10. The back box 9 can be adhered to the wall plate 19 in some embodiments, or otherwise mechanically connected to the wall plate 19, and may be arranged to be relatively movable (e.g., by screwing a threaded connection or by a ratcheting mechanism) to trap a wall 12 therebetween and thereby fix the electrical port 5 to the wall 12. In some embodiments, the back box 9 and wall plate 19 may be integrally formed as a unitary or monolithic component. As shown, a wire 3 can have first tool-less connector 18 at an end thereof. In the illustrated embodiment, the first connector 18 can comprise a male connector, for example, a snap-fit or clip connector. The port body 20 can have a second tool-less connector 22, as shown in FIG. 5, which may be complementary to the first connector 18. As shown in FIG. 5, the second tool-less connector 22 can comprise a female connector, for example, a female snap-fit or clip connector. In some embodiments, as explained herein, the wall plate 19 can be inserted into an opening or hole 14 of the wall 12 by way of a tool-less connection 18, 22 (e.g., snapped or clipped into the opening), as shown in FIG. 4.

In various embodiments, for example, the back box 9 can be incorporated into the electrical port 5, e.g., into a switch or outlet plate 19 for the port 5. In various embodiments, the front plate 19 for the port 5 (e.g., for a switch, outlet, powered device or other port) can also be provided by a tool-less connection. For example, in some embodiments, an installer 2 can insert the plate 19 into the wall 12 by way of a snap-fit or clip connection. Furthermore, the front plates 19 can beneficially include rounded holes and/or plates instead of rectangular holes and/or plates.

In some embodiments, a first end of the wire 3 can be connected to the junction box with a first tool-less connection 18 (e.g., snap-fit or clip connection), and a second end of the wire 3 can be connected to a port 5 such as a switch (e.g., a light switch) by a tool-less connection 18 (e.g., snap-fit or clip connection). A first end of a second wire 3 can connect to the switch by a tool-less connection (e.g., snap-fit or clip connection), and a second end of the second wire 3 can connect to a light bulb or other electrical device or load by a tool-less connection (e.g., snap-fit or clip connection).

Accordingly, various embodiments disclose an electrical system 1 for a stationary structure, such as a building structure 10. The electrical system 1 can comprise a harness 15 in some embodiments. The harness 15 can comprise at least one primary bundle 16 of a plurality of electrical wires 3. At least one end of one or more electrical wires 3 of the plurality of electrical wires 3 can comprise a tool-less electrical connector 18. The harness 15 can comprise a plurality of wire branches 17 extending from the at least one primary bundle 16. Each wire branch 17 of the plurality of wire branches 17 can include a set of one or more wires 3 from the plurality of electrical wires 3. The harness 15 can be constructed such that each wire branch 17 of the plurality of wire branches 17 is configured to connect to one or more corresponding electrical ports 5 of the structure 10.

In various embodiments, the electrical system 1 may be constructed as part of a kit that is initially not installed in the structure 10. For example, the electrical system 1 can be constructed at a location that is different from the structure 10 and can be transported to the structure 10 to install the electrical system 1 in the structure 10. As explained herein, in some embodiments, the structure 10 comprises a residential house. In some embodiments, the structure 10 comprises a commercial building, industrial site, etc.

In various embodiments, the one or more corresponding electrical ports 5 can provide electrical power to the same room of the structure 10. The one or more corresponding electrical ports 5 can comprises an electrical outlet 6, a light switch 7, a powered device 8, or any other suitable electrical socket or structure that is to be connected to the junction box 4. In various embodiments, both ends of the one or more wires 3 comprise respective tool-less connectors 18 for connecting to the junction box 4 and the one or more electrical ports 5. The tool-less connector 18 can be configured to snap or clip into a corresponding connector 22 of an electrical port 5, and this connection can be made by hand, without tools and without even the need for insulated gloves for this work. In some embodiments, the one or more electrical ports 5 can be configured to be installed in a floor, ceiling 11, or wall 12 of the structure 10, the one or more electrical ports 5 configured to connect to the structure 10 by way of a tool-less connection (for example, a snap-fit or clip connection). In some embodiments, the system 1 does not include a separate back box 9 for each electrical port 5.

In some embodiments, the system 1 can include the electrical port 5. The electrical port 5 can also comprise a tool-less connector 22 configured to connect to an electrical wire 3 without tools. The tool-less connector 22 can be configured to snap or clip to the corresponding connector 18 of the electrical wire 3. The electrical port 5 can comprise one or more of a front plate 19 and a back box 9. In some embodiments, the electrical port 5 can comprise a front plate 19 with an integrated back box 9. In some embodiments, the electrical port 5 can comprise a light switch 7 or an electrical outlet 6.

In various embodiments, a method for installing an electrical system 1 in a building structure 10 is disclosed. The method can include connecting respective first ends of a plurality of wires 3 to a junction box 4 of the structure 10 with a first tool-less connection. The method can include connecting respective second ends of the plurality of wires 3 to corresponding electrical ports 5 in the structure 10 with a second tool-less connection.

In some embodiments, the plurality of wires 3 can be bundled together in a harness 15 having a primary wire bundle 16 and a plurality of wire branches 17 extending from the at least one primary bundle 16. The method can include designing and assembling the harness 16 at a location that is different from the structure 10. The method can include installing the electrical ports 5 in one or more walls 12 (or floor or ceiling 11) of the structure 10 with a third tool-less connection. One or more of the first and second tool-less connections can comprise a snap-fit or clip connection.

In various embodiments, an electrical port 5 configured to be installed in a building structure 10 is disclosed. The electrical port 5 can comprise a port body 20 comprising a tool-less connector 22 configured to electrically and mechanically connect to an electrical wire 3 without using any tools.

In some embodiments, the tool-less connector 22 can be configured to connect to the electrical wire 3 by way of a snap-fit or clip connection. The port body 20 comprises a light switch 7 in some embodiments. In some embodiments, the port body comprises a switch or front plate 19. In some embodiments, the port body 20 can comprise an electrical outlet 6. In some embodiments, the port body 20 can comprise a back box 9.

In various embodiments, a junction box 4 configured to be installed in a building structure 10 is disclosed. The junction box 4 can include a plurality of electrical connectors configured to supply electrical power to a plurality of electrical ports 5 in the building structure 10. The tool-less connector may be generally similar to or the same as the connectors 18, 22 described herein. At least one electrical connector of the plurality of electrical connectors can comprise a tool-less connector configured to electrically and mechanically connect to an electrical wire 3 without using any tools. In some embodiments, the tool-less connector can be configured to connect to the electrical wire 3 by way of a snap-fit or clip connection.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. An electrical system for a building structure, the electrical system comprising:
a harness comprising:
at least one primary bundle of a plurality of electrical wires, wherein at least one end of one or more electrical wires of the plurality of electrical wires comprises a tool-less electrical connector; and
a plurality of wire branches extending from the at least one primary bundle, each wire branch of the plurality of wire branches comprising a set of one or more wires from the plurality of electrical wires,
wherein the harness is constructed such that each wire branch of the plurality of wire branches is configured to connect to one or more corresponding electrical ports of the building structure.

2. The system of claim 1, wherein the electrical system is not installed in the building structure.

3. The system of claim 1, further comprising the building structure, wherein the electrical system is installed in the building structure.

4. The system of claim 1, wherein the building structure comprises a house.

5. The system of claim 1, wherein the one or more corresponding electrical ports provide electrical power to the same room of the building structure.

6. The system of claim 1, wherein the one or more corresponding electrical ports comprises an electrical outlet.

7. The system of claim 1, wherein the one or more corresponding electrical ports comprises a light switch.

8. The system of claim 1, wherein both ends of the one or more wires comprise respective tool-less connectors.

9. The system of claim 1, wherein the tool-less connector is configured to snap or clip into a corresponding connector of an electrical port.

10. The system of claim 1, further comprising an electrical port, the electrical port comprising a tool-less connector configured to connect to an electrical wire without tools.

11. The system of claim 10, wherein the tool-less connector is configured to snap or clip to the electrical wire.

12. The system of claim 10, wherein the electrical port comprises one or more of a front plate and a back box.

13. The system of claim 10, wherein the electrical port comprises a front plate with an integrated back box.

14. The system of claim 10, wherein the electrical port comprises a light switch or an electrical outlet.

15. The system of claim 1, wherein the one or more electrical ports are configured to be installed in a wall of the building structure, the one or more electrical ports configured to connect to the wall by way of a tool-less connection.

16. The system of claim 1, wherein the system does not include a separate back box for each electrical port.

17. A method for installing an electrical system in a building structure, the method comprising:
connecting respective first ends of a plurality of wires to a junction box of the building structure with a first tool-less connection; and
connecting respective second ends of the plurality of wires to corresponding electrical ports in the building structure with a second tool-less connection.

18. The method of claim 17, further comprising bundling the plurality of wires together in a harness a primary wire bundle and a plurality of wire branches extending from the at least one primary bundle.

19. The method of claim 18, further comprising designing and assembling the harness at a location that is different from the building structure.

20. The method of claim 17, further comprising installing the electrical ports in one or more walls of the building structure with a third tool-less connection.

21. The method of claim 17, wherein one or more of the first and second tool-less connections comprise a snap-fit of clip connection.

22. An electrical port configured to be installed in a building structure, the electrical port comprising:
a port body comprising a tool-less connector configured to electrically and mechanically connect to an electrical wire without using any tools.

23. The electrical port of claim 22, wherein the tool-less connector is configured to connect to the electrical wire by way of a snap-fit or clip connection.

24. The electrical port of claim 22, wherein the port body comprises a light switch.

25. The electrical port of claim 24, wherein the port body comprises a switch plate.

26. The electrical port of claim 22, wherein the port body comprises an electrical outlet.

27. The electrical port of claim 22, wherein the port body comprises a back box.

28. A junction box configured to be installed in a building structure, the junction box comprising:
a plurality of electrical connectors configured to supply electrical power to a plurality of electrical ports in the building structure, wherein at least one electrical connector of the plurality of electrical connectors comprises a tool-less connector configured to electrically and mechanically connect to an electrical wire without using any tools.

29. The junction box of claim 28, wherein the tool-less connector is configured to connect to the electrical wire by way of a snap-fit or clip connection.
